(19) United States
(12) Patent Application Publication
(10) Pub. No.: US 2022/0316550 A1
(43) Pub. Date: Oct. 6, 2022

(54) ANTI-VIBRATION MOUNT USING COMBINATION OF MULTIPLE SPRINGS

(71) Applicant: KOREA RAILROAD RESEARCH INSTITUTE, Uiwang-si, Gyeonggi-do (KR)

(72) Inventor: Seung-Ho JANG, Gunpo-si, Gyeonggi-do (KR)

(73) Assignee: KOREA RAILROAD RESEARCH INSTITUTE, Uiwang-si, Gyeonggi-do (KR)

(21) Appl. No.: 17/312,389

(22) PCT Filed: May 3, 2021
(86) PCT No.: PCT/KR2021/005549

§ 371 Date: Jun. 9, 2021

(30) Foreign Application Priority Data
May 13, 2020 (KR) 10-2020-0057288

(51) Int. Cl. F16F 15/02; F16F 15/06

(52) U.S. Cl. CPC F16F 15/022; F16F 15/06; F16F 2238/026

(57) ABSTRACT

Proposed is an anti-vibration mount using combination of multiple springs in which a main spring is provided between an upper frame and a lower frame to reduce vibration, and an auxiliary spring is provided at each of the side portions of the upper frame such that the direction and magnitude of a force applied by the auxiliary spring change according to the compressed degree of the main spring, so the effect of an air spring is realized only with the combination of the main and auxiliary springs which are coil springs. The anti-vibration mount includes: the upper frame allowing an object to be installed thereon; the lower frame provided under the upper frame by being spaced apart therefrom; the main spring provided between the upper frame and the lower frame; and the auxiliary spring elastically supporting each of opposite sides of the upper frame and the lower frame.

### TECHNICAL FIELD

The present disclosure relates generally to an anti-vibration mount using combination of multiple springs. More particularly, the present disclosure relates to an anti-vibration mount using combination of multiple springs in which a main spring is provided between an upper frame and a lower frame to reduce vibration, and an auxiliary spring is provided at each of side portions of the upper frame such that the direction and magnitude of a force applied by the auxiliary spring change according to the compressed degree of the main spring, so the effect of an air spring is realized only with the combination of the main and auxiliary springs which are coil springs.

### BACKGROUND ART

In a conventional anti-vibration mount installed in a path through which vibration and impact are transmitted, coil springs, leaf springs, anti-vibration rubber, and air springs, etc. are used. They support an object to be prevented from vibrating (hereinafter referred to as “object”), and function to support a load and to block vibration and impact.

The performance of such an anti-vibration device is related to stiffness thereof and a damping value thereof, and the mass of cargo. In particular, the lower limit of low frequency in a frequency band in which vibration reduction occurs is proportional to the square root of the stiffness and is inversely proportional to the square root of the mass.

Accordingly, when an object having different weight is placed on the anti-vibration mount, the anti-vibration performance of the anti-vibration mount is changed. When the stiffness of the anti-vibration mount is increased to support the weight of the object, the lower limit of the low frequency at which vibration reduction occurs is increased, so it is difficult to reduce the vibration or impact of low frequency.

In addition, when a mount having low stiffness is used to reduce the vibration and impact of the low frequency, the amount of deflection of the mount caused by a load is large, so the height of the anti-vibration mount is required to be increased greatly. In this case, space occupied by the anti-vibration mount is excessively increased, so it is difficult to realistically apply the anti-vibration mount.

This situation occurs in coil springs, leaf springs, and mounts made of anti-vibration rubber.

On the other hand, in the case of an air spring mount, it is more advantageous to block the vibration/impact of a sprung mass while supporting the sprung mass (a load) by using air pressure. FIG. 1 illustrates the load-displacement characteristics of a normal air spring mount, and the inclination of a load-displacement graph corresponds to stiffness of the air spring mount. The stiffness is large at an initial stage in which a load is 0, and when the air spring mount reaches an operation section, the stiffness thereof decreases, and when the air spring mount exceeds the operation section, the stiffness thereof increases again.

Accordingly, due to low stiffness of the air spring mount in the operation section, the air spring mount has an excellent anti-vibration performance in a low frequency range, and can support a high load.

In such an air spring mount, air pressure is generated by operating an air compressor by using electricity or engine power, and a support load (corresponding to a load in the operation section in the graph) can be adjusted by controlling the air pressure.

However, in the air spring mount, air may leak, and when air pressure drops below a predetermined level, the air is required to be replenished by operating the air compressor.

Accordingly, to use the air spring mount, external power is required, and thus additional parts such as a compressor, an accumulator, and an air valve block, etc. are required. Accordingly, the air spring mount is not only complicated in structure and difficult to be maintained, but also has high manufacturing costs, and has relatively poor durability due to the aging of air hoses and rubber bellows.

### DISCLOSURE

### Technical Problem

Accordingly, the present disclosure has been made keeping in mind the above problems occurring in the related art, and the present disclosure is intended to propose an anti-vibration mount using combination of multiple springs in which a pair of main springs is provided between an upper frame and a lower frame to reduce vibration; a spring guide is provided between the upper frame and the lower frame in a revolute joint method; and an auxiliary spring is provided at the outer side of the spring guide, whereby the direction and magnitude of a force applied by the auxiliary spring change according to the compressed degree of the main spring in a side portion of the main spring, so the effect of an air spring is realized with the combination of the main and auxiliary springs which are coil springs.

### Technical Solution

In order to achieve the above objectives, an anti-vibration mount using combination of multiple springs according to the present disclosure includes: an upper frame allowing an object to be installed thereon; a lower frame provided under the upper frame by being spaced apart therefrom; a main spring provided between the upper frame and the lower frame; and an auxiliary spring elastically supporting each of opposite sides of the upper frame and the lower frame.

Here, a support bracket may be formed at each of opposite sides of the lower frame by protruding upward therefrom, and a spring guide may be elastically provided inside the auxiliary spring, wherein a first end part of the spring guide may be hinged to an upper end of the support bracket, and a second end part of the spring guide may be hinged to the upper frame.

In addition, the spring guide may include: a first guide allowing an end part thereof to be hinged to the upper frame; and a second guide allowing an end part thereof to be hinged to the upper end of the support bracket, wherein the first guide may be installed slidably in a through hole formed through the second guide.

In this case, a first support plate may be formed at the end part of the first guide, the first support palate supporting a first end part of the auxiliary spring, and a second support plate may be formed at the end part of the second guide, the second support plate supporting a second end part of the auxiliary spring.

Meanwhile, a link member may be provided at a center part of a lower surface of the upper frame, and the end part of the first guide may be hinged to each of opposite sides of a lower end of the link member.

Here, a bump stop may be provided at a center part of the lower frame so as to support the lower end of the link member.

In addition, a damper may be provided inside the main spring.

### Advantageous Effects

According to the present disclosure having the above-described configuration, the pair of main springs is provided between the upper frame and the lower frame so as to reduce vibration; the spring guide is provided between the upper frame and the lower frame in a revolute joint method; and the auxiliary spring is provided at the outer side of the spring guide, whereby the direction and magnitude of a force applied by the auxiliary spring change according to the compressed degree of the main spring in a side portion of the main spring, thereby realizing the effect of an air spring with the combination of the main and auxiliary springs which are coil springs.

### DESCRIPTION OF DRAWINGS

FIG. 1 is a view showing load-displacement characteristics of a conventional air spring mount.

FIG. 2 is a perspective view of an anti-vibration mount using combination of multiple springs according to the present disclosure.

FIG. 3 is a sectional view of the anti-vibration mount using combination of multiple springs according to the present disclosure.

FIG. 4 is a front view of the anti-vibration mount using combination of multiple springs according to the present disclosure.

FIGS. 5A and 5B are state views of the anti-vibration mount using combination of multiple springs according to the present disclosure, respectively, moved downward by a load.

FIG. 6 is a load-displacement graph of the anti-vibration mount using combination of multiple springs according to the present disclosure.

### Best Mode

Hereinafter, an exemplary embodiment of the present disclosure will be described further in detail with reference to the accompanying drawings. The same reference numerals are used for the same elements in the drawings, and duplicate descriptions for the same elements are omitted. In addition, it should be understood that the present disclosure may be implemented in various different forms and is not limited to the described embodiment.

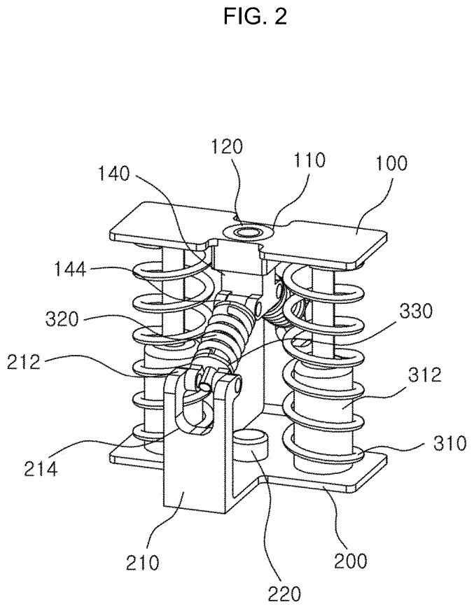

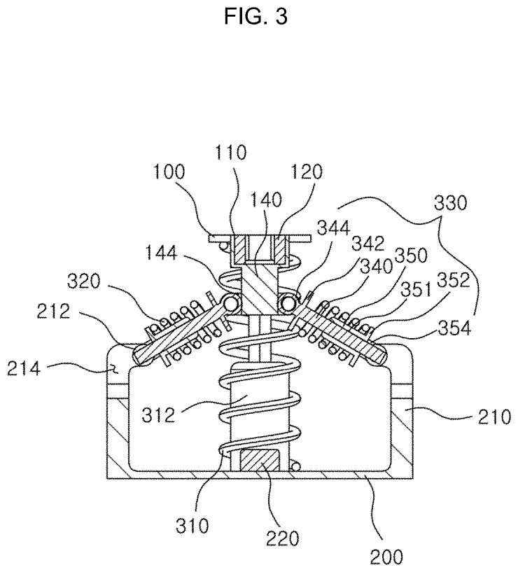

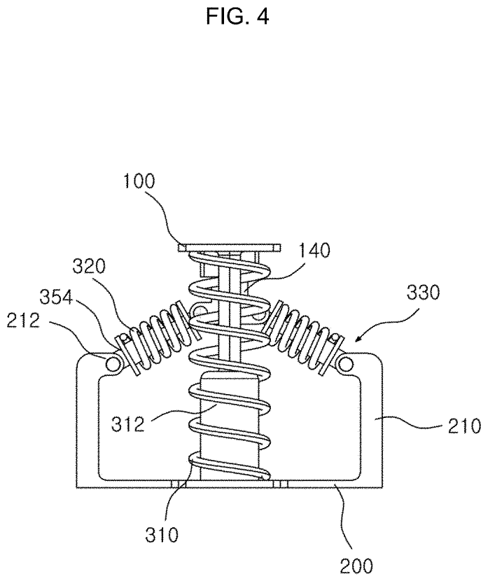

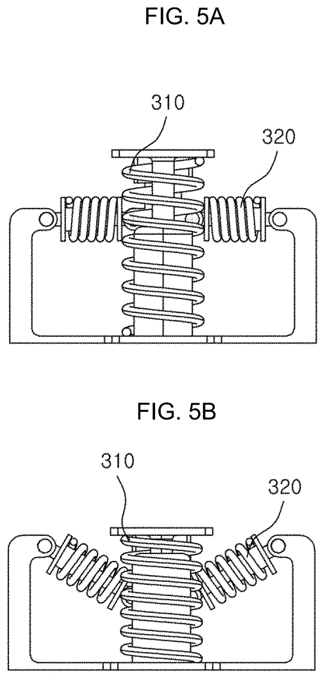

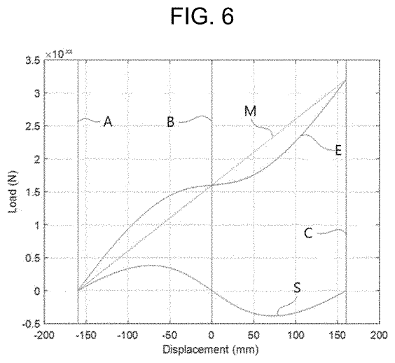

FIG. 2 is a perspective view of an anti-vibration mount using combination of multiple springs according to the present disclosure; FIG. 3 is a sectional view of the anti-vibration mount using combination of multiple springs according to the present disclosure; FIG. 4 is a front view of the anti-vibration mount using combination of multiple springs according to the present disclosure; FIGS. 5(a) and 5(b) are state views of the anti-vibration mount using combination of multiple springs according to the present disclosure, respectively, moved downward by a load; and FIG. 6 is a load-displacement graph of the anti-vibration mount using combination of multiple springs according to the present disclosure.

The present disclosure relates to the anti-vibration mount using combination of multiple springs, and as illustrated in FIGS. 2 to 6, the anti-vibration mount is composed of an upper frame 100 configured to have a plate shape; a lower frame 200 provided under the upper frame 100 by being spaced apart therefrom; and main springs 310 provided between the upper frame 100 and the lower frame 200.

Here, an object is installed on the upper frame 100 such that the vibration of the object is prevented, and the lower frame 200 is fixed on a support part supporting the object to be prevented from vibrating. Although the upper frame 100 is illustrated to have a rectangular shape in FIG. 2, the shape of the upper frame 100 is not limited thereto, and may have various shapes such as the shape of a polygonal plate or a circular plate.

In this case, auxiliary springs 320 elastically supporting opposite sides of the upper frame 100 and the lower frame 200, respectively, are provided, wherein the auxiliary springs 320 are installed to be symmetrical to each other.

That is, a first end part of each of the auxiliary springs 320 is located to be biased to the center part of the upper frame 100, and a second end part of the auxiliary spring 320 is located to be biased to an edge of the lower frame 200.

Accordingly, when each of the main springs 310 is compressed by a load of the object, the angle and compressed degree of the auxiliary spring 320 change, so the direction and magnitude of a force applied by the auxiliary spring 320 are changed.

In addition, as illustrated in FIG. 2, the lower frame 200 may be configured to have a cross shape, but may be configured to have various shapes such as the shape of a square plate or a circular plate. A support bracket 210 is formed at each of the opposite sides of the lower frame 200 by protruding upward therefrom.

Here, the support bracket 210 may include multiple pairs of support brackets. For convenience of description, as illustrated in the drawing, the support bracket 210 is configured as a pair of support bracket. The pair of support brackets 210 is installed to be symmetrical to each other as the auxiliary springs 320 are installed to be symmetrical to each other.

In this case, a spring guide 330 is elastically provided inside the auxiliary spring 320. A first end part of the spring guide 330 is hinged to the upper end of the support bracket 210, and a second end part of the spring guide 330 is hinged to the upper frame 100.

Meanwhile, the spring guide 330 is composed of a first guide 340 configured to have a bar shape and a second guide 350 configured to have a pipe shape. The first guide 340 is slidably inserted to a through hole formed through the second guide 350 in a longitudinal direction thereof, so the length of the spring guide 330 changes.

Here, a first hinge bracket 344 is formed at an end part of the first guide 340 and is hinged to the upper frame 100, and a second hinge bracket 354 is formed at an end part of the second guide 350 and is hinged to a second hinge part 212 formed at the upper end of the support bracket 210.

In this case, a first support plate 342 is formed at the end part of the first guide 340 by protruding outward therefrom, the first support plate supporting a first end part of the auxiliary spring 320, and a second support plate 352 is formed at an end part of the second guide 350 by protruding outward therefrom, the second support plate supporting a second end part of the auxiliary spring 320.

Accordingly, when the upper frame 100 is moved downward by the load of an object installed on the upper frame 100, the angle of the spring guide 330 changes while the length of the spring guide 330 decreases, so the direction and magnitude of a force applied to the upper frame 100 by the auxiliary spring 320 change.

Correlation between loads acting on the main spring 310 and the auxiliary spring 320 and the displacements thereof is illustrated in FIG. 6. FIG. 6 is a graph in which line M indicates the main spring 310; line S indicates the auxiliary spring 320; and line E indicates a resultant force of the main spring 310 and the auxiliary spring 320.

That is, in the graph of FIG. 6, a B position in which displacement indicated on a horizontal axis is 0 indicates that the vertical displacements of the main and auxiliary springs in a situation illustrated in FIG. 5(a) are 0. As the upper frame 100 moves upward, the displacements become negative, and as the upper frame 100 moves downward, the displacements become positive. The vertical axis of FIG. 6 refers to the load of an object and vertical forces applied to the load by the main spring 310 and the auxiliary spring 320. When the vertical forces act in upward directions, the displacements become positive, and when the vertical forces act in downward directions, the displacements become negative.

More specifically, an A position of FIG. 6 indicates a situation illustrated in FIG. 4; the B position indicates a situation illustrated in FIG. 5(a); and a C position indicates a situation illustrated in FIG. 5(b).

That is, when the load is 0 as in the A position, the main spring 310 and the auxiliary spring 320 are completely stretched, and when the load increases, the main spring 310 and the auxiliary spring 320 are compressed, so the vertical forces thereof act due to the restoring forces of the main and auxiliary springs which are coil springs.

In this case, the main spring 310 is vertically installed, so the vertical force of the main spring 310 acts only upwards, and thus is indicated as a straight line in the graph. However as the main spring 310 is compressed by the load, the auxiliary spring 320 has an angle changed as illustrated in FIG. 6. Force acting horizontally is offset by each of the auxiliary springs 320 installed symmetrically at the opposite sides of the upper frame, and force acting vertically that is the vertical force of the auxiliary spring increases as the auxiliary spring is compressed, but the upward vertical force of the auxiliary spring decreases according to the acting direction of the vertical force. Accordingly, the upward vertical force of the auxiliary spring decreases when the load passes a certain point, so the load-displacement graph of the auxiliary spring is shown as a sine curve.

Here, as illustrated in FIG. 5(a), when the auxiliary springs 320 are horizontal, the vertical forces of the auxiliary springs 320 disappear as seen in the B position of FIG. 6 and the horizontal forces of the auxiliary springs 320 are offset each other. When the load further increases, a situation contrary to a situation described above occurs. The compressed degree of the coil spring (the auxiliary spring) decreases and the horizontal force thereof decreases, but as the acting direction of the vertical force of the auxiliary spring changes, the vertical force of the auxiliary spring increases. Accordingly, the vertical force acting downward in a negative direction increases, and when the load passes a certain point, the compressed degree of the auxiliary spring significantly decreases, so the vertical force acting downward in the negative direction decreases.

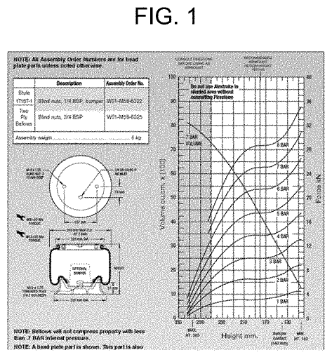

Accordingly, the sum of the forces applied by the main spring 310 and the auxiliary spring 320 in the directions perpendicular to the load is shown as line E, which is the same as the state of an air spring illustrated in FIG. 1.

That is, when the main spring 310 and the auxiliary spring 320 are in the state of the B position while an object is installed on the anti-vibration mount by adjusting the load of the object appropriately or by adjusting the elastic forces of the main spring 310 and the auxiliary spring 320 to match the load, the stiffnesses of the main spring 310 and the auxiliary spring 320 corresponding to the inclinations of the graph are close to 0. Accordingly, the lower limit of a frequency band in which vibration generated by the object can be reduced is lowered, so low-frequency vibration can also be significantly reduced like the use of an air spring.

Therefore, in the anti-vibration mount of the present disclosure, only the combination of the coil springs may perform the same operation as the vibration-reducing operation of an air spring, and thus many auxiliary devices for installing the air spring are not required to be installed, thereby greatly reducing manufacturing costs, realizing a simple structure, and greatly reducing entire volume.

Of course, when the load of an object is changed, the coil spring is required to be correspondingly changed, but the anti-vibration mount is easily installed at low cost and is used in continental railways in which objects having the same loads are moved for a long time or at places at which changes of loads are not large.

Meanwhile, a link member 140 is provided at the center part of the lower surface of the upper frame 100, and a first hinge part 144 is formed at each of the opposite sides of the lower end of the link member 140, so the first hinge bracket 344 formed at the end part of the first guide 340 is hinged to the lower end of the link member 140.

Here, the link member 140 may be formed at the center part of the lower surface of the upper frame 100 by protruding downward therefrom, or may be separately manufactured to be fixed to the lower surface of the upper frame 100.

In addition, the link member 140 is illustrated to be formed at the center part of the lower surface of the upper frame 100 in the drawing. However, as described above, the link member 140 may be formed and may allow the spring guide 330 to be connected thereto, or without the installation of the link member 140, a hinge part may be formed at the upper frame 100 and the upper end of the spring guide 330 may be directly hinged to the upper frame 100.

In addition, a damper 312 is provided inside the main spring 310, wherein the lower end of the damper 312 is fixed to the lower frame 200 and the upper end of the damper 312 is installed under the upper frame 100.

Accordingly, the damper 312 improves an impact-reducing performance of the coil spring by adding damping characteristics insufficient in the coil spring to the coil spring, and also allows vibration energy to dissipate more quickly.

In this case, a bump stop 220 is provided at the center part of the upper surface of the lower frame 200. The bump stop 220 is made of a material having high elasticity such as rubber or synthetic rubber, and thus supports a lower end of a link member 140 when the link member 140 is moved downward by the load of an object, so impact applied to the bump stop 220 during the collision of the bump stop 220 with the link member 140 is buffered.

Meanwhile, an installation recess 110 is formed at the center part of the upper frame 100 so as to install an object therein. A busing 120 is installed in the installation recess 110 and minute vibrations applied in the horizontal direction are attenuated by the bushing 120.

Although the exemplary embodiment of the present disclosure has been described above, the scope of the present disclosure is not limited thereto, and extends to those that are within a range substantially equal to the embodiment of the present disclosure. The embodiment of the present disclosure may be variously modified by those skilled in the art to which the present disclosure belongs without departing from the spirit of the present disclosure.

### Industrial Applicability

The present disclosure relates generally to the anti-vibration mount using combination of multiple springs. More particularly, the present disclosure relates to the anti-vibration mount using combination of multiple springs in which the main spring is provided between the upper frame and the lower frame to reduce vibration, and the auxiliary spring is provided at each of the side portions of the upper frame such that the direction and magnitude of a force applied by the auxiliary spring change according to the compressed degree of the main spring, so the effect of an air spring is realized only with the combination of the coil springs.

1. An anti-vibration mount using combination of multiple springs, the anti-vibration mount comprising:
an upper frame allowing an object to be installed thereon;
a lower frame provided under the upper frame by being spaced apart therefrom;
a main spring provided between the upper frame and the lower frame; and
an auxiliary spring elastically supporting each of opposite sides of the upper frame and the lower frame.

2. The anti-vibration mount of claim 1, wherein a support bracket is formed at each of opposite sides of the lower frame by protruding upward therefrom, and
a spring guide is elastically provided inside the auxiliary spring, wherein a first end part of the spring guide is hinged to an upper end of the support bracket, and a second end part of the spring guide is hinged to the upper frame.

3. The anti-vibration mount of claim 2, wherein the spring guide comprises:
a first guide allowing an end part thereof to be hinged to the upper frame; and
a second guide allowing an end part thereof to be hinged to the upper end of the support bracket,
wherein the first guide is installed slidably in a through hole formed through the second guide.

4. The anti-vibration mount of claim 3, wherein a first support plate is formed at the end part of the first guide, the first support palate supporting a first end part of the auxiliary spring, and
a second support plate is formed at the end part of the second guide, the second support plate supporting a second end part of the auxiliary spring.

5. The anti-vibration mount of claim 3, wherein a link member is provided at a center part of a lower surface of the upper frame, and
the end part of the first guide is hinged to each of opposite sides of a lower end of the link member.

6. The anti-vibration mount of claim 5, wherein a bump stop is provided at a center part of the lower frame so as to support the lower end of the link member.

7. The anti-vibration mount of claim 1, wherein a damper is provided inside the main spring.
